(19) United States
(12) Patent Application Publication
(10) Pub. No.: US 2008/0071660 A1
(43) Pub. Date: Mar. 20, 2008

(54) System for Displaying Results of Purchases/Sales of Share Investment Fund Shares on a Stock Exchange

(75) Inventor: Andrey Vyacheslavovich Shmakov, Moscow (RU)

Correspondence Address: ABELMAN, FRAYNE & SCHWAB, 666 THIRD AVENUE, 10TH FLOOR, NEW YORK, NY, 10017, US

(73) Assignee: AKTSYONERNOE OBSCHESTVO "GLOBAL ENERDZHI INVEST KOMPANI", Luxembourg (LU)

(21) Appl. No.: 11/573,037

(22) PCT Filed: Jun. 8, 2005
(86) PCT No.: PCT/RU05/00317

§ 371 Date: Jan. 31, 2007

(30) Foreign Application Priority Data
Mar. 15, 2005 (RU) 2005107196

(51) Int. Cl. G06Q 40/00; G06T 1/00

(52) U.S. Cl. 705/36 R

(57) ABSTRACT

An informational computerized system displays the buy/sell result of the shares of Share Investment Funds at the stock exchange, and includes a processing unit with software connected via cable links with units for text and graphic information display and for data input. The processing unit is equipped with functions for data reception via the input unit and storage of database information, and a function for real time share cost calculation by the software and representation of the digital equivalent cost of this share for each Share Investment Fund on the screen or in a creeping line in the form of the share price index computed as the summated products of the securities quantities forming the property of the fund and their estimated prices plus monetary remainders on the commercial and settlement accounts of the corresponding Share Investment Fund, divided by the shares quantity of this fund.

### CROSS-REFERENCE TO RELATED APPLICATIONS

This application is a 371 of international application number PCT/RU2005/0003 17, filed on Jun. 8, 2005.

### BACKGROUND OF THE INVENTION

1. Field of the Invention

The invention relates to systems and methods of data computation and processing, specially assigned for specific credit and financial operations by way of stock turnover as a variety of securities.

2. Description of the Related Art

There is a well-known prior art system showing the result of the purchase/sale of shares performed by the Share Investment Funds (hereinafter referred to as “SIF”) at the stock exchange, that includes a processing unit equipped with corresponding software and connected via links with a text and graphic information display unit and an input unit (RU No. 2187149, G06F17/60, published on Aug. 10, 2002).

The deficiency of the prior art system, applied as a transactions tool at the share stock exchange, is the use of the share value computation algorithm with insufficiently effective information value and reliability. The information concerning the securities quantity forming the SIF assets is received from the clearing center that is represented by the depository and clearing company. The information concerning the monetary remainders on the commercial accounts is received from the clearinghouse. The data on the prices on the latest transactions is received from the commercial servers of the stock exchange.

The information concerning the shares quantity and the remainders on SIF settlement accounts is prepared by the managing company upon the data given from banks where the settlement accounts are open, and from the special bailee who takes into account the shares quantity changes at the moment of share purchases or repayments by shareholders. Once a day, before the tenders begin, this information is transmitted to the stock exchange and does not vary within the trading day.

The managing companies may purchase and repay the shares at the shareholders only at the price, computed by way of the following technique of the share cost computation: the initial securities quantity at the beginning of the day is multiplied by the average price after the final analysis of the day. Then the total sum of assets is divided by the shares quantity. As a result the share transactions can be performed via the managing company only by yesterday's prices that can be quite different from the today's prices.

Today's major constraint that restrains the active exchange trade of SIFs is a lack of the reliable and timely information on the SIF's property cost per share. Only with such information could the professional market participants manage bilateral investment share quotations, and the investors could perform buy/sell transactions with SIFs at the stock exchange. The structure of the SIF's portfolio and operation with its assets is restricted information; therefore, to define what exactly occurs with the share cost in case of the various stocks quotations' growth or falling is not obviously possible for the other market participants.

It is obvious that the shareholder who buys/sells the shares via the managing company in the view of the existing normative documents of the regulating authorities can get unreasonable profit or loss in comparison to the other shareholders as the price is determined by way of the abovementioned technique. This explains the existence of the considerable markups during the share purchase and the considerable markdowns during the share sell so that the persons possessing the insider's information on the real share cost could not get unreasonable profits. Besides, the entire procedure of the shares purchase and repayment does not give the shareholders an opportunity to perform active operations on shares. Under the existing legislation, the managing company can define the share repayment price within 3 days after reception of the repayment tender and then up to 15 days can detain paying back the tender.

The investment share transactions via the stock exchange can fundamentally increase the public's respect for the investment funds institute. All that is necessary for this purpose is to be able to obtain the property cost per share in real time. If the SIF's property only consists of the exchange financial tools, its cost may always be estimated at the latest transactions prices of the stock exchange. And since the shares quantity does not vary within the day, the SIF's property cost per share may be easily calculated.

### BRIEF SUMMARY OF THE INVENTION

The present invention is destined to solve the technical task of introducing the disclosed corresponding algorithm into the display system of the trading results at the stock exchange in order to obtain the property cost per share in real time.

The achieved technical result shows thereby the increase of the informative value and data reliability of the trading results as a result of the displayed representation of the real share cost upon each transaction results.

The stated technical result is achieved by the following: in the display system of share buy/sell results of Share Investment Funds at the stock exchange that includes the processing unit equipped with the corresponding software and connected via cable links with the text and graphic information display unit and the input unit, the text and graphic information display unit is designed as a screen or a creeping line; that is, an information, data, or news crawl-type display on the screen; the processing unit is equipped with functions for data reception via the input unit and storage of database information about the shares quantity of each Share Investment Fund participating in stock exchange tenders, about the remainders on the settlement accounts, about the monetary remainders on the commercial accounts and about the securities quantity in the property of each stated fund, and the function for real time share cost calculation by the specified software and representation of the digital equivalent cost of this share for each Share Investment Fund on the screen or in a creeping line in the form of the share price index computed as the summated products of the securities quantities forming the fund's property and their estimated prices plus monetary remainders on the commercial and settlement accounts of the corresponding Share Investment Fund, divided by the shares quantity of this fund.

A creeping line is defined herein as any type of display of information, data, or news using a moving, changing, and/or crawling-type display on any portion of a display screen; for example, in a narrow line or rectangular strip or region located, for example, on the bottom of a display which simulates or evokes a traditional paper-based printed output of a stock ticker.

The specified attributes are essential and are interconnected so that the formed steady combination of these essential attributes is sufficient to obtain the specified technical result.

### BRIEF DESCRIPTION OF THE SEVERAL VIEWS OF THE DRAWINGS

The present invention is described in the specific example, which, however, is not the only one possible, but clearly shows an opportunity of achieving the required technical result via the set of the mentioned attributes.

Preferred embodiments of the invention are disclosed hereinbelow with reference to the drawings.

FIG. 1 is a schematic showing the layout of the display system of share buy/sell results of the Share Investment Funds at the stock exchange.

### DETAILED DESCRIPTION OF THE INVENTION

The present invention is related to international application number PCT/RU2005/0003 17, filed on Jun. 8, 2005, which is incorporated herein by reference in its entirety.

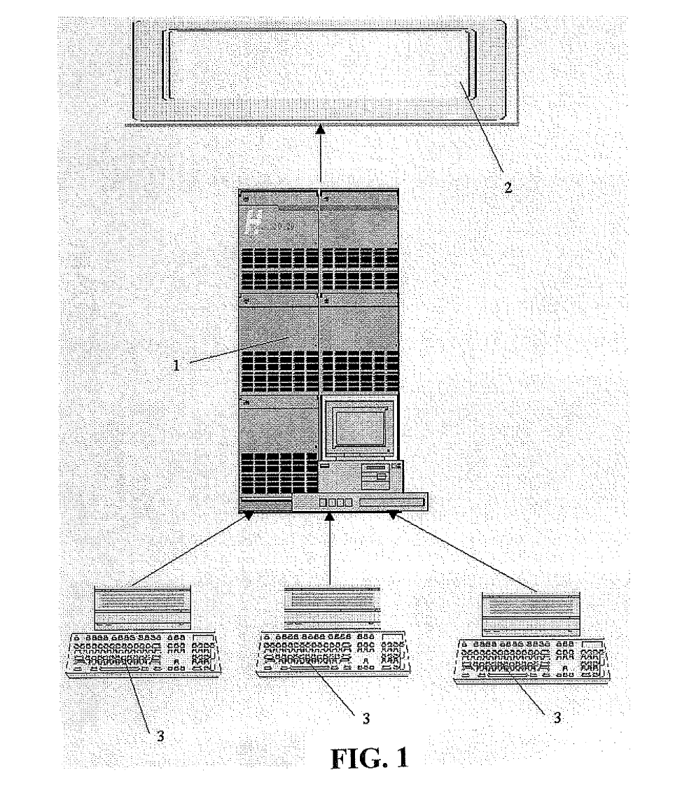

According to the present invention, as shown in FIG. 1, an informational computerized display system for the display of share buy/sell results of the Share Investment Funds at the stock exchange includes the processing unit 1 connected via cable links to the text and graphic information display unit 2 and the at least one data input unit 3. The text and graphic information display unit 2 is designed to include and/or display a screen or a creeping line.

The processing unit 1, the text and graphic information display unit 2, and the data input unit 3 represent well-known components of any computerized system.

The processing unit 1 is equipped with corresponding software for implementing the system and method disclosed herein.

The processing unit 1 is equipped with software and/or computer hardware to perform a function for storage of database information about the shares quantity of each Share Investment Fund participating in stock exchange tenders, about the remainders on the settlement accounts, about the monetary remainders on the commercial accounts and about the securities quantity in the property of each stated fund. The specified information is keyed in via the data input unit.

The processing unit 1 is also equipped with software and/or hardware to perform a function using the above-mentioned software for share cost calculating in real time mode and showing the digital equivalent share cost in each Share Investment Fund on the screen or in a creeping line in the form of the share price index computed as the summated products of the securities quantities forming the find's property and their estimated prices plus monetary remainders on the commercial and settlement accounts of the corresponding Share Investment Fund, divided by the shares quantity of this fund.

The model algorithm of the share cost calculation function is as follows:

1. Before the tenders start, the stock exchange receives the information from the managing company in the following way:

a) the statements on the shares quantity forming the fund;

b) the statements on the remainders at the SIF's settlement accounts.

These data do not vary within the day. All the changes of the shares quantity in case of the shares repayment or selling will be executed after the tenders termination.

2. The stock exchange has the real time information on the securities quantity and the monetary remainders on commercial accounts forming the fund's property.

3. The latest transaction price is considered as a calculated price qualifying the security cost. It within the day, no transactions on the security occurred, the closing price of the previous day is used.

4. The SIP's net asset value (NAV) is calculated as the summated products of the securities quantities forming the fund's property and their estimated prices plus monetary remainders on the commercial and settlement accounts.

5. The SIF's property value per share is calculated as NAV divided by the shares quantity.

The information is updated in case of fund assets transactions or in case of changes in the latest transaction price of the issuer's securities forming the SIF's investment portfolio This value in the form of the share price index is broadcast at the stock exchange by the same ways as the exchange indices are broadcast.

The share price (cost) index Iₜ at the estimated time is computed as a ratio of the total market cost St of the SIF's net asset at a current time to the shares quantity Nₜ: Iₜ=Sₜ/Nₜ, where

$${S}_{t} = {\sum }_{i = 0}^{N} {P}_{i} \cdot {Q}_{i} + {M}_{b} + {M}_{r}$$

and Qᵢ is the securities quantity of the i^{th} designation belonging to the SIF at the current moment; Pᵢ is the price of the i^{th} security for the estimated time; M_{b} is the SIF's monetary remainder on the commercial account in the trading system of the stock exchange; Mᵣ is the total SIF's monetary remainders on its settlement accounts updated by the value of the notes and bills payable; and N is a number of the securities designations in the SIF's investment portfolio.

If during the current trading session the transactions with the given securities were executed, the latest transaction price is considered as Pᵢ for the i^{th} security; and if no transactions with the given securities were executed during the current trading session, the closing price of the last day is considered as Pᵢ for the i^{th} security.

In recent years, the collective investments market shows a high dynamic of growth, however, the shareholders had an opportunity to receive the information on the net asset value and share cost only after the trading session termination. The present invention will allow making the share pricing more transparent, i.e. the share cost indicator will allow the investors to trace its dynamics within the trading day and efficiently make their decisions concerning the shares selling or purchase. The computation of such an indicator will promote the popularization and growth of the secondary market liquidity of the given tools.

### INDUSTRIAL APPLICATION

The present invention is industrially applicable for it can be realized in widely used computerized systems and corresponding software, that can process the entered data according to the incorporated algorithm according to the formula given in the description.

While the preferred embodiment of the present invention has been shown and described herein, it will be obvious that such embodiment is provided by way of example only. Numerous variations, changes and substitutions will occur to those skilled in the art without departing from the invention herein. Accordingly, it is intended that the invention be limited only by the spirit and scope of the appended claims.

1. (canceled)

2. A display system of share buy/sell results of the Share Investment Funds at the stock exchange, the display system comprising:
a text and graphic information display unit having a screen or a creeping line display;
a data input unit; and
a processing unit equipped with software and connected via cable links with the text and graphic information display unit and the data input unit, with the processing unit being equipped with functions for data reception via the input unit and storage of database information about the shares quantity of each Share Investment Fund participating in the stock exchange tenders, about the remainders on the settlement accounts, about the monetary remainders on the commercial accounts and about the securities quantity in the property of each stated fund, and a function for real time share cost calculation by the specified software and representation of the digital equivalent cost of this share for each Share Investment Fund on the screen or in the creeping line in the form of the share price index computed as the summated products of the securities quantities forming the fund's property and their estimated prices plus monetary remainders on the commercial and settlement accounts of the corresponding Share Investment Fund, divided by the shares quantity of this fund.
